(19) United States
(12) Patent Application Publication
(10) Pub. No.: US 2004/0180573 A1
(43) Pub. Date: Sep. 16, 2004

(54) Connection-safe network hub

(76) Inventor: Heng-Ching Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/384,592

(22) Filed: Mar. 11, 2003

(51) Int. Cl. H01R 11/00

(52) U.S. Cl. 439/502

(57) ABSTRACT

Disclosed is a connection-safe network hub adapted for connection through a 6-wire RJ12 cable as the media for transmission of data and power. Each pin on the RJ12 jack leads to a respective wire embedded in the RJ12 cable, where the first two pins are used for transmitting data, the last two pins for receiving data, and the middle two pins for supplying DC power to all on-line network devices. This pin definition for the RJ12 jack not only provides a framework for orderly transmission of data and power through the network cable, it can also prevent misconnection from network devices having different pin definitions in the interface.

### BACKGROUND OF THE INVENTION

1. Field of the Invention

The present invention relates to a connection-safe network hub, in particular to a network hub that is adapted for both data transfer and power distribution using a common interface, and the design of which is able to prevent misconnection from network devices having different pin definitions in the interface.

2. Description of Related Arts

The Ethernet is generally constructed by connecting a number of network devices in series with a coaxial cable to form a local area network for bidirectional data exchange. The transmission rate of network cables has substantially upgraded over the years from 10, 100 to the present 1000 Mbps. The fast Ethernet cable is now not only used for building computer networks, it can also be used by other microprocessor-based devices like internet protocol (IP) phones, point of sale (POS) systems, closed-circuit surveillance equipment and alarm systems. The IP phone, for example, now has many more functions than just a voice transmission telephone, incorporating functions such as data exchange and conversion and video display. These IP phones therefore need a DC power supply to support the various new functions. For conventional Ethernet hubs, as shown in FIG. 4, network devices (80), using an IP phone in this example, are connected to a server (not shown) through a network hub (70), wherein the network hub (70) provides input and output ports for connecting to the network devices (80) through RJ45 jacks (71) using an 8-wire RJ45 cable. According to the pin definitions for RJ45, the RJ45 jack only provides data transmission and reception, as the pin definitions for the RJ45 jack are listed out in the following table:

| Pin number | Function |
|---|---|
| 1 | Data transmit (TX) |
| 2 | Data transmit (TX) |
| 3 | Data receive (RX) |
| 4 | Free |
| 5 | Free |
| 6 | Data receive (RX) |
| 7 | Free |
| 8 | Free |

According to the protocol for the conventional Ethernet, the network cables are only used of transmission of data signals, without supporting the power distribution. However, to meet the upgraded functions of the network devices, the new generation of the 8-wire network cable is capable of supporting both data transfer and power distribution, where the power supply either comes from a backplane or a standalone power supply unit, providing the necessary DC power for the operation of the network devices. The previously unused copper wires corresponding to pins 4, 5, 7 and 8 of the RJ45 jack (71) are available for power transmission by selecting either pair of the twisted copper wires.

Although the above-mentioned technique can provide the power supply for network devices connected on local network, it also creates another problem. The conventional Ethernet protocol only employs two pairs of wires in the 8-wire cable for data transfer, with the rest reserved for future systems. Even if one pair of the unused wires is used for power distribution, there is still one pair free. When a network device is designed to use the RJ45 interface for data transfer only, the unused wires are not affected, but when one pair of unused wires is designated for power distribution, there is a risk of a mismatch between the data pin and the power pin of the RJ45 interface. The network device or peripheral device using the RJ45 interface may not have the same pin definition, thus voltage signals are not expected by some devices connected onto the network, which may cause short circuits in the system hardware or at least some data errors. If the cable is designed both for data transfer and power distribution, precautionary steps have to be taken to prevent misconnection from network devices having different pin definitions in the interface.

### SUMMARY OF THE INVENTION

The main object of the present invention is to provide a network hub that can support data transfer and power distribution simultaneously, and is able to prevent misconnection by other network devices with different pin definitions in the interface.

In order to accomplish the above-mentioned object the network hub is to use an RJ12 jack as the standard interface. The RJ12 jack has 6 pins for connecting to 6 wires in the network cable, wherein the six wires in the cable are configured in pairs, with the first two pins as a pair used for data transmit (TX), and the last two pins as a pair for data receive (RX), and the middle two pins as a pair for supplying DC power.

Using the above mentioned architecture, the network hub is adapted for data and power distribution, and its device interface is an RJ12 jack to differentiate from the RJ45 jack commonly used by Ethernet-based local area network, therefore the RJ12 jack in accordance with the present invention can effectively prevent misconnection by network devices having different pin definitions in the interface. Also, using the pair of pins in the middle of the jack for power distribution will not create the polarity problem whichever way the connector is inserted, thus facilitating the hub assembly in the production.

The above mentioned network hub includes a media access controller (MAC), a physical layer (PHY) and an internal power unit, wherein the physical layer is formed by a controller chip and a transceiver, and the internal power unit provides the operating power for the media access controller (MAC) and the physical layer (PHY), and it also provides the necessary DC power for network devices.

The power unit includes a first power supply circuit and a second power supply circuit, wherein the first power supply circuit provides the operating power for the media access controller (MAC), the physical layer (PHY) and other embedded devices, and the second power supply unit is connected to the power bus for providing DC power to all on-line network devices.

The above mentioned network hub can be constructed with a switching hub or a repeater hub depending on the particular network requirement.

The features and structure of the present invention will be more clearly understood when taken in conjunction with the accompanying drawings.

### BRIEF DESCRIPTION OF THE DRAWINGS

FIG. 1 shows an IP phone being connected to the network hub in accordance with the present invention;

FIG. 2 is a block diagram of the architecture of the network hub.

FIG. 3 is the block diagram of the structure of a network device interface; and

FIG. 4 is a perspective view of a conventional network hub.

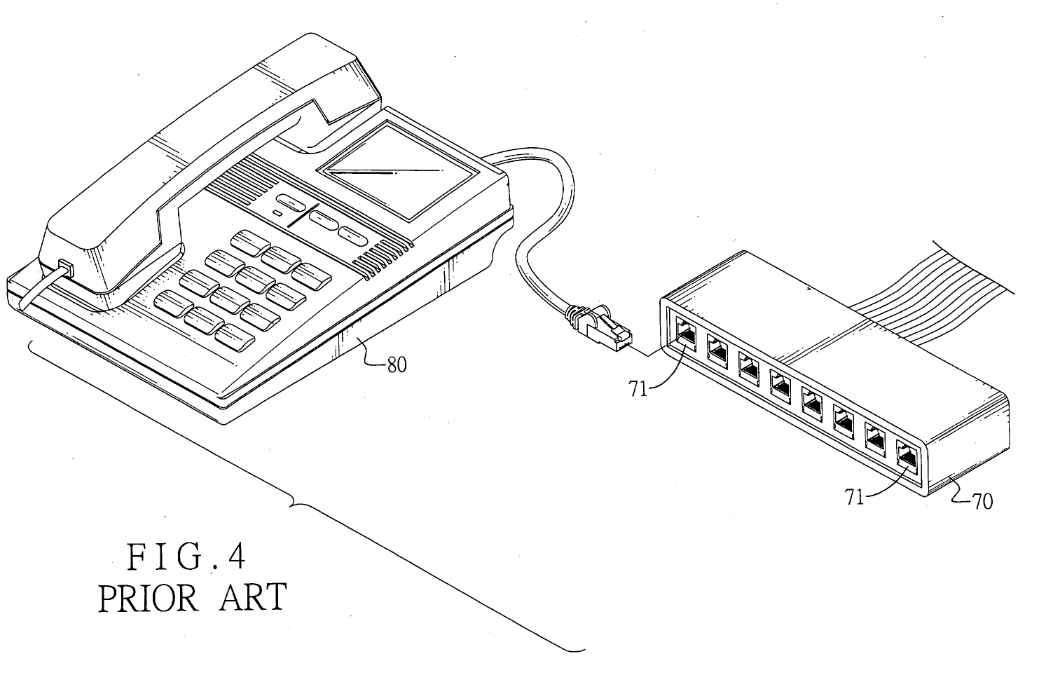

### DETAILED DESCRIPTION OF THE PREFERRED EMBODIMENT

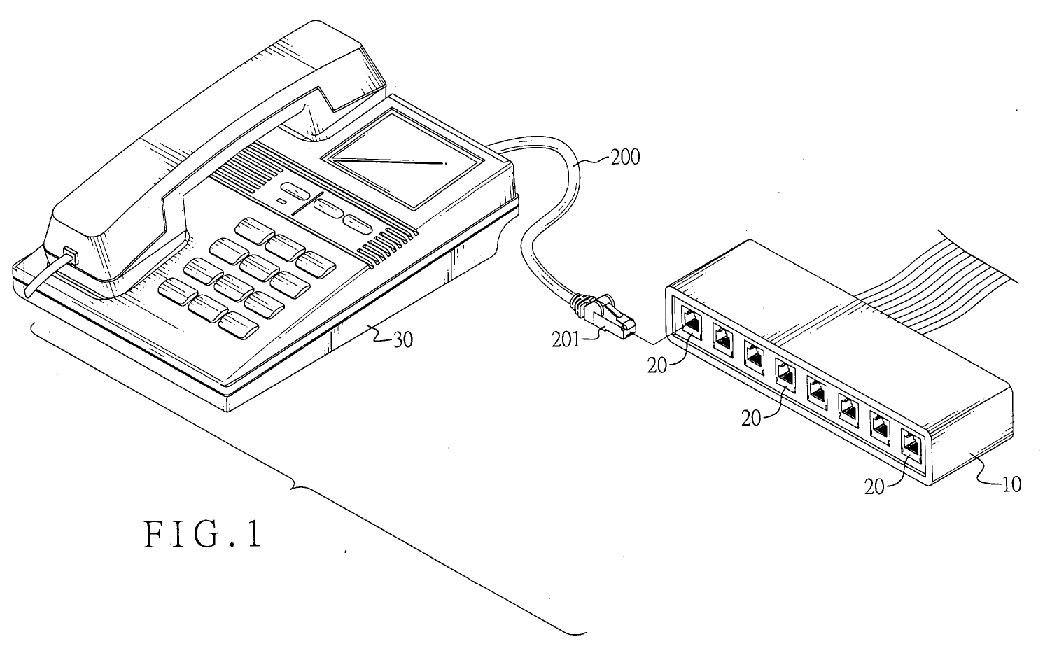

The present invention provides a connection-safe network hub as shown in FIG. 1, comprising:

a repeater hub or a switching hub (10) using an RJ12 jack (20) for connecting to the network devices or peripheral devices, in the present example an IP phone, using a common interface adapted for both data transfer and power distribution. The network device (30) is connected to the hub (10) through a 6-wire cable (200) with the RJ12 connector (201) thereon mated with the RJ12 jack (20) of the network hub (10).

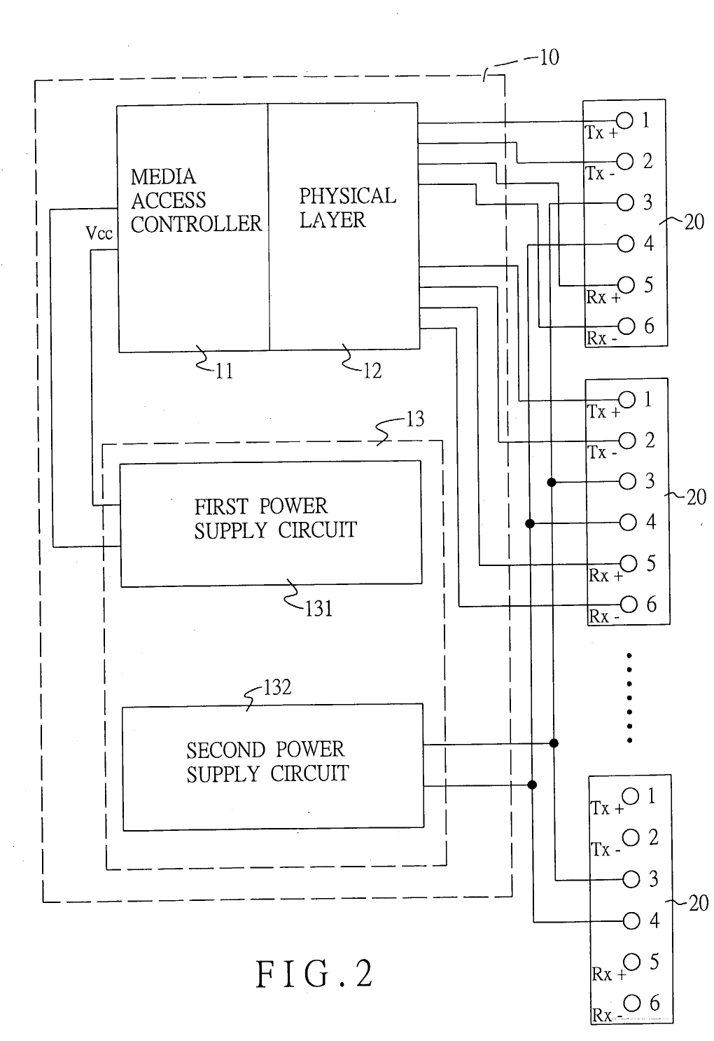

The pins of the RJ12 jack (20) are defined as shown in FIG. 2, wherein pins 1, 2 of the RJ12 jack (20) are used for data transmit (TX+/TX−), and pins 5, 6 are used for data receive (RX+/RX−), and pins 3, 4, disposed in between the transmit and receive pins for power distribution. To prevent cross-talking of signals, the data transmit and receive wires are formed by pairs of twisted copper wires.

According to the design of the present invention, the power outlet on the network hub (10) is also adapted to use the RJ12 jack as a device interface, which differentiates from the conventional RJ45 jack for Ethernet use. The RJ12 jack contains 6 pins as compared with the 8 pins in the RJ45 jack; therefore the port size is different from that of the RJ45 jack, thus effectively preventing misconnection from network devices using conventional RJ45 jacks.

The architecture of the network hub (10) in accordance with one preferred embodiment comprises:

a media access controller (MAC) (11) used for controlling data access to the media which is connected to the physical layer (PHY) for data transmission or data reception;

a physical layer (12) formed by a controller chip and a transceiver; and

a power unit (13) for providing the operating power to the media access controller (11), the physical layer (12) and the power bus to be connected by all the network devices.

In actual implementation, the functions of the media access controller (11) and the physical layer (12) can be integrated into a controller IC responsible for packetizing and data transfer.

In the preferred embodiment, the power unit (13) is divided up into a first power supply circuit (131) and a second power supply circuit (132), wherein the first power supply circuit (131) provides the operating power to the media access controller (11), and the physical layer (12), whilst the second power supply circuit (132) provides DC power to the power bus which is connected by all network devices (30) using pins 3, 4 of the RJ12 jacks (20) to draw DC power to the network device (30). In order to reduce the chance of signal crosstalk, the second power supply circuit (132) provides 24V DC to the network devices (30) through the 6-pin RJ12 jack (20) and 6-wire cable (200).

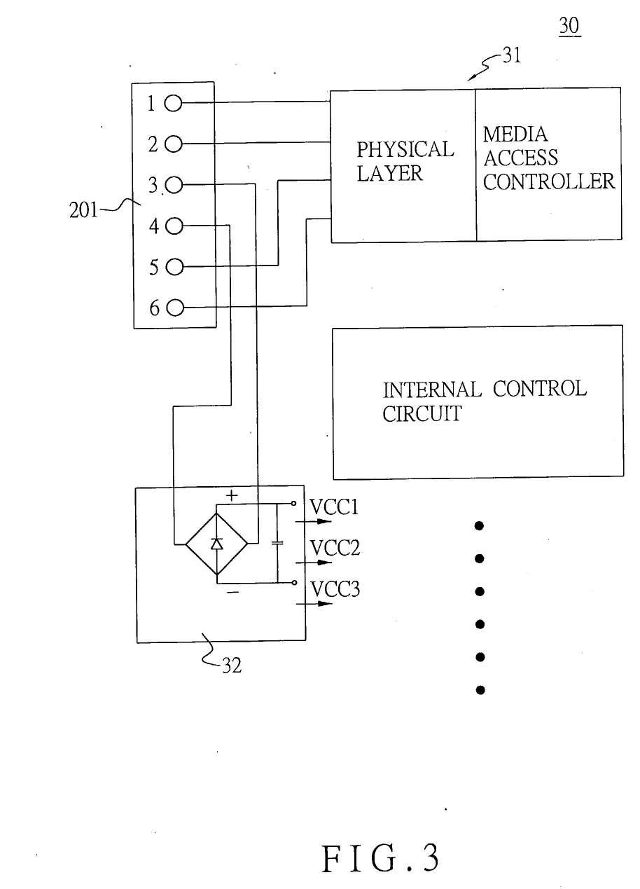

In FIG. 3, each network device (30) connecting to the hub (10) for data transfer and power supply needs to be equipped with at least:

a link control unit (31) formed by a media access controller (MAC) and a physical layer component (PHY), using the RJ12 jack (201) as the interface;

a power unit (32) that draws on power from the network hub (10) through the RJ12 connector (201), which can be converted to become multiple DC outputs (VCC1˜VCC3) for supplying the link control unit (31) and various other internal components.

From the foregoing, it is clear that the present invention uses the RJ12 connector as the common interface for data transfer and power distribution, and the physical appearance of the RJ12 jack is different from the conventional RJ45 for Ethernet use. This special design is needed to prevent misconnection by the network devices with different data pin and/or power pin definitions in the interface. Besides, since the pair of pins in the middle of the RJ12 jack is designated as the power pins, polarity will not become a problem whichever way the connector is inserted, thus facilitating the assembly of the hub in the production.

The foregoing description of the preferred embodiments of the present invention is intended to be illustrative only and, under no circumstances, should the scope of the present invention be so restricted.

What is claimed is:

1. A connection-safe network hub using an RJ12 jack as the standard interface for data transfer and power distribution, wherein each RJ12 jack has 6 pins for connecting to 6 wires of network cable in pairs, with the first two pins for TX, the last two pins for RX, and the middle two pins for supplying DC power.

2. The connection-safe network hub as claimed in claim 1, wherein the network hub comprises a media access controller (MAC), a physical layer (PHY), and a power unit, wherein the power unit supplies the DC power to the MAC and PHY and a common power bus connecting to various on-line network devices.

3. The connection-safe network hub as claimed in claim 2, wherein the power unit is divided up into a first power supply circuit and a second power supply circuit, wherein the first power supply circuit provides the operating power to the media access controller and the physical layer, whilst the second power supply circuit provides DC power to a common power bus for supplying on-line network devices.

4. The connection-safe network hub as claimed in claim 1, wherein the network hub is constructed with a repeater hub.

5. The connection-safe network hub as claimed in claim 2, wherein the network hub is constructed with a repeater hub.

6. The connection-safe network hub as claimed in claim 3, wherein the network hub is constructed with a repeater hub.

7. The connection-safe network hub as claimed in claim 1, wherein the network hub is constructed with a switching hub.

8. The connection-safe network hub as claimed in claim 2, wherein the network hub is constructed with a switching hub.

9. The connection-safe network hub as claimed in claim 3, wherein the network hub is constructed with a switching hub.
